(19) United States
(12) Patent Application Publication
(10) Pub. No.: US 2018/0293213 A1
(43) Pub. Date: Oct. 11, 2018

(54) Reduced Memory Footprint Font Sample Strings

(71) Applicant: Microsoft Technology Licensing, LLC, Redmond, WA (US)

(72) Inventors: Abhijit Gore, Redmond, WA (US); Theo Lorrain-Hale, Redmond, WA (US); Simon Hindocha-Daniels, Seattle, WA (US)

(21) Appl. No.: 15/480,684

(22) Filed: Apr. 6, 2017

(51) Int. Cl. G06F 17/22; G06F 17/28; G06F 17/21

(52) U.S. Cl. CPC G06F 17/2217; G06F 17/214; G06F 17/289

(57) ABSTRACT

The generation of sample string font files comprises identifying a language supported by a given font, rendering a sample textual content for that language in that font, encoding the rendered sample textual content as a single, cohesive glyph, storing that glyph in a sample string font file and then recording, within one or more tables, a correspondence between the language, the font and that location. A sample string font file comprises glyphs that are sample textual content of a single language rendered in multiple different fonts, glyphs that are sample textual content of multiple languages rendered in a same font which supports all of those different languages, or combinations thereof. Appropriate sample string font files are downloaded to a local computing device in accordance with user interface language settings, and the sample textual content, as rendered in different fonts, is presented through font selection user interface mechanisms.

### BACKGROUND

When creating or editing textual content users can choose to represent such textual content in different typefaces, commonly referred to as “fonts”. The selection, by the user, of a particular font for a particular set of textual content is often a design choice that is left to the user's discretion. In choosing which fonts to use, it is beneficial to users to have some example of what textual content rendered in such a font looks like. However, to generate such an example requires that the entire font be available to the user on the computing device on which the user is creating or editing textual content, which typically requires that the font be stored locally on such a computing device. Often, content creation applications will provide users with access to hundreds of fonts, and the local storage of such fonts can take many hundreds of megabytes.

In an effort to present, to the user, a visual representation of what textual content in a font would look like, applications can present the name of the font, such as in a font menu selection mechanism, rendered visually in its own font. One mechanism for doing so again requires that the entire font be locally stored on the user's computing device, and, thereby, again has the aforementioned drawback of consuming too much local storage capacity. Another mechanism for presenting the name of a font visually rendered in that font is to locally store only a subset of the font, mainly only those characters, corresponding spacing information, and the like, necessary to render the font's name in that font. However, such a mechanism results in duplicated data once the complete font file is downloaded, or otherwise obtained, so that text other than just the name of the font can be rendered in that font. Moreover, font names can be poor examples through which to show a user what textual content rendered in a font looks like. For example, fonts names are often short with only a few characters, making it difficult for user to be able to visualize how a much larger collection of textual content, with many other characters, will visually appear when rendered in that font. Another problem is that the letters in a font name are purely arbitrary and, as such, the font name itself can provide a poor sample on which the user's font selection decision is based. Yet another problem is that fonts names are often in English even for fonts that are used for scripts other than Latin. For example, Devanagari script fonts, whose intended usage is not for English text, but instead for other languages, may nevertheless have English names, in which case the name of the font cannot be accurately rendered in that font.

### SUMMARY

To provide users with an example of the visual appearance of textual content in a given font, which is consistent across fonts for a given language and comprises a greater quantity of textual characters than merely the font's name, thereby providing the user with a better and more complete example on which to base their font selection decisions, while at the same time consuming a reduced amount storage capacity, a sample string font file can be created which comprises glyphs, such that each individual, single glyph is a whole sample textual content in a given language as rendered in a given font. The generation of one or more such sample string font files comprises identifying a language supported by a given font, rendering a sample textual content for that language in that font, encoding the rendered sample textual content as a single, cohesive glyph, storing that glyph in a sample string font file and then recording, within one or more tables, a correspondence between the language, the font and that location. A sample string font file, therefore, can comprise glyphs that are sample textual content of a single language rendered in multiple different fonts, glyphs that are sample textual content of multiple languages rendered in a same font which supports all of those different languages, or combinations thereof. Appropriate sample string font files can be downloaded to a local computing device in accordance with user interface language settings of such a computing device, and the sample textual content, as rendered in different fonts, can be presented to a user through font selection user interface mechanisms.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a system diagram of an exemplary system for generating sample string font files;

FIG. 2 is a block diagram of an exemplary sample string glyph generator;

FIG. 3 is a flow diagram of an exemplary series of steps by which sample string font files can be generated;

FIGS. 4a and 4b are block diagrams of exemplary user interfaces displaying sample strings; and

FIG. 5 is a block diagram of an exemplary computing device.

### DETAILED DESCRIPTION

The following description relates to the provision of examples of the visual appearance of textual content, also termed “sample strings” in a given font. Such sample strings comprise a greater quantity of textual characters than merely the font's name and thereby provide the user with a better and more complete example on which to base their decision of which font to use to render textual characters. To consume a reduced amount storage capacity, a sample string font file can be created which comprises glyphs, such that each individual, single glyph is a whole sample textual content in a given language as rendered in a given font. The generation of one or more such sample string font files can comprise identifying a language supported by a given font, rendering a sample textual content for that language in that font, encoding the rendered sample textual content as a single, cohesive glyph, storing that glyph in a sample string font file and then recording, within one or more tables, a correspondence between the language, the font and that location. A sample string font file, therefore, can comprise glyphs that are sample textual content of a single language rendered in multiple different fonts, glyphs that are sample textual content of multiple languages rendered in a same font which supports all of those different languages, or combinations thereof. Appropriate sample string font files can be downloaded to a local computing device in accordance with user interface language settings of such a computing device, and the sample textual content, as rendered in different fonts, can be presented to a user through font selection user interface mechanisms, including sizing the sample textual content to match other font selection interfaces.

The techniques described herein make reference to “fonts” and “font files”. As utilized herein, the term “font” means “typeface”, namely a specific graphical representation of textual characters. The term “font file” means a computer-readable data file comprising information to enable a computing device to visually render, on a display device communication coupled to the computing device, or on a hardcopy generation device, such as a printer, coupled to the computing device, textual characters in one or more typefaces. The descriptions below will also make reference to “glyphs” and “scripts”. As utilized herein, the term “glyph” means a visual element, comprising textual characters defined in vector-based terms, or other mathematical representations of outlines of those textual characters, to the exclusion of bitmap images of textual characters, where such textual characters include symbols, pictograms, hieroglyphs, and other textual characters, that is treated by processes executing on a computing device as a single, cohesive visual element. Similarly, the term “script”, is utilized herein, means a system of writing, such as is utilized to express words in one or more languages.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

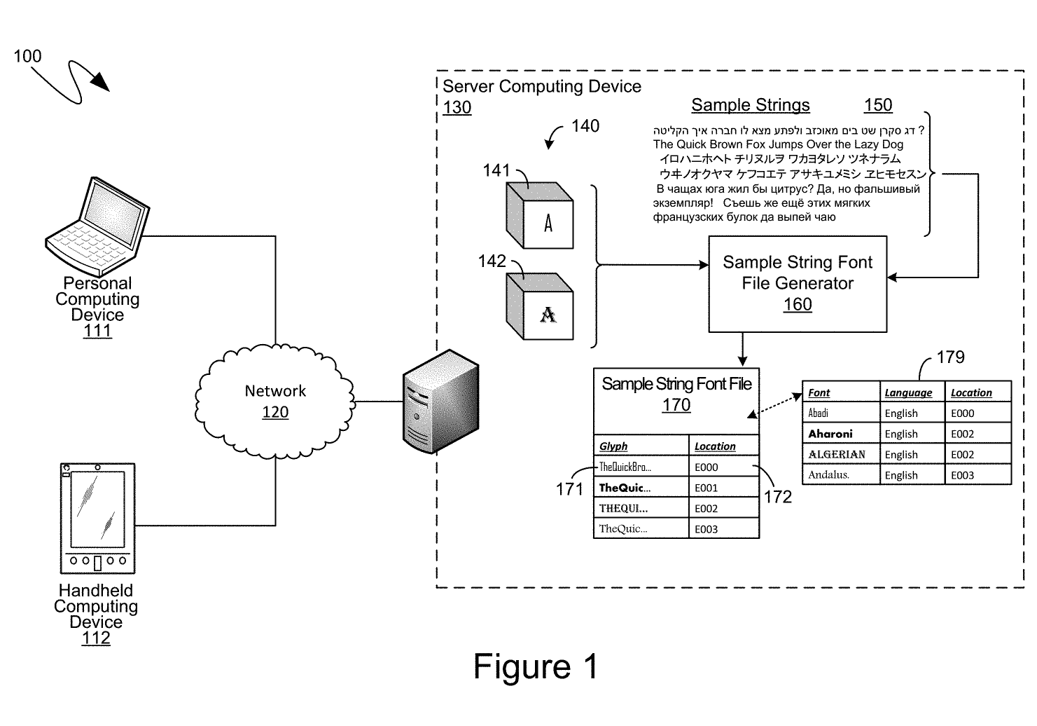

With reference to FIG. 1, an exemplary system 100 is illustrated, providing context for the descriptions below. The exemplary system 100 can include, but is not limited to, one or more user-controlled computing devices, such as the exemplary personal computing device 111, and the exemplary handheld computing device 112, which can be communicationally coupled to other computing devices, including, for example, the exemplary server computing device 130, via the exemplary network 120. As will be described further below, a user can utilize one of the user computing devices, such as the exemplary personal computing device 111, or the exemplary handheld computing device 112, to generate textual content, such as via one or more content creation applications. As part of the generation of such textual content, the user can be provided, through such content creation applications, with the opportunity to render such textual content within one or more typefaces, commonly referred to as “fonts”. While the choice of which font to use to render textual content is typically a design choice left to the user's discretion, users are often presented with hundreds of fonts from which to choose from, and enabling the user to make an informed decision can make the user more efficient, and more accurate, in their utilization of the computing device. While font names can be visually displayed rendered in their own font, font names are often too short, and simply comprise too few characters, to enable user to accurately determine what their textual content will look like when rendered in such a font. Consequently, to provide users with a more accurate assessment of what textual content rendered in a font will look like, exemplary textual content in the form of sample strings of textual content, hereinafter referred to as “sample strings”, can be presented to the user, with each such sample string rendered in a font available to the user to select.

In order to render sample strings in a font, the user's computing device, such as the exemplary personal computing device 111, or the exemplary handheld computing device 112, can require that the font file corresponding to such a font already be installed on that computing device. In instances where hundreds of fonts are available, the font files of such hundreds of fonts can easily comprise fifty megabytes or more of storage capacity, which can decrease the performance of the user's computing devices. The storage capacity consumed by such hundreds of font files further represents an inefficient use of storage capacity, since most users are unlikely to utilize the vast majority of such fonts. To enable a user to make an informed selection regarding which font to render their textual content in, while at the same time consuming a reduced amount of storage capacity, sample string font files can be utilized, as described further herein. As will be shown, such sample string font files can consume only a small fraction of the storage capacity that would otherwise be consumed by having a complete font file for each of hundreds of fonts installed on the user's computing devices, while at the same time enabling sample strings to be rendered in each such font, thereby enabling the user to more accurately select fonts, and increase the efficiency with which they utilize and interact with their personal computing devices.

According to one aspect, one or more computing devices, such as exemplary server computing device 130, can comprise sample string font file generators, such as the exemplary sample string font file generator 160, which can receive, as input, one or more font files, such as the exemplary font files 140, as well as one or more language specific sample strings, such as the sample strings 150, and output therefrom one or more sample string font files, such as exemplary sample string font file 170. Although illustrated and described with reference to server computing devices, the sample string font file generation mechanisms described herein can be equally executed by a single personal computing device, or by a collection of personal computing devices, and then the resulting sample string font files can be uploaded to one or more server computing devices, and downloaded therefrom by users' personal computing devices to enable those users' personal computing devices to render the sample strings in various fonts in accordance with the mechanisms described further below. Sample strings, such as the exemplary sample strings 150, can comprise a sample string in each of multiple different languages. For each language, a sample string can be selected comprising words or phrases within such a language that provides a meaningful example of what characters, words, or other like textual content rendered in a font will look like. For example, a pangram can be utilized where the words, in a given language, of the pangram comprise, among them, all of the characters of the alphabet of such a language. A well-known pangram in English is the sentence: “the quick brown fox jumped over the lazy dog”. Other languages have similar pangrams. According to another aspect, a well-known phrase, statement, or other like exemplary textual content can be utilized, even if such textual content is not a pangram, or does not otherwise utilize all, or essentially all, of the characters of an alphabet.

The sample strings 150 can be provided in tabular, database, or other like format that correlates a given exemplary textual content to a specific language, or a specific script. The font files 140 can comprise individual font files, such as the exemplary font files 141 and 142, in accordance with standard font file formats. As will be recognized by those skilled in the art, font files, such as exemplary font files 140, comprise glyphs of individual characters of the font represented by the font file, thereby enabling the computing device to visually render textual content in such a font on one or more display devices that are communicationally coupled to such a computing device. In addition, as will also be recognized by those skilled in the art, font files typically comprise tabular content that specifies various aspects of how individual glyphs are to be assembled, including spacing information and the like, as well as other rendering information. Font files can further comprise information regarding the scripts or languages for which such a font can be utilized.

According to one aspect, a sample string font file generator, such as the exemplary sample string font file generator 160, can iterate through a collection of font files, such as the exemplary font files 140. For each font file in the font files 140, the sample string font file generator 160 can identify one or more languages, or scripts, to which such a font applies. For each such language or script, the sample string font file generator 160 can identify a corresponding sample string, from among the sample strings 150, that is in such a language. The sample string font file generator 160 can then render such a sample string in the font, utilizing the rendering information contained within the corresponding font file, such as one of the exemplary font files 141 and 142.

To reduce storage capacity, while still providing the user with a sample string rendered in a given font, the sample string font file generator 160 can generate a single glyph from the sample string rendered in a particular font. Such a single glyph can then be stored at a particular location within a newly created font file, such as the exemplary sample string font file 170. Typically, within a font file, glyphs are stored at identified locations, often referred to as “code points”, and font files often comprise tables, such as a “cmap” table that correlates a specific glyph to a specific code point, Unicode value, or other like unique location identifier within the font file. Accordingly, the single glyph generated by the sample string font file generator 160, of an entire sample string rendered in a given font, can be stored in a single such location, within the sample string font file 170, and a corresponding location at which such a sample string glyph is stored, can be recorded. For example, the sample string font file 170 is illustrated in FIG. 1 as comprising a table that correlates individual glyphs, such as the exemplary glyph 171, with a corresponding location within the font file, such as exemplary location 172.

The sample string font file generator 160 can further generate a correspondence between a single glyph of a sample string of a particular language rendered in a particular font, and the font within which such a sample string was generated, as well as the corresponding language. Such a three-way correspondence, between the sample string glyph, the corresponding language, and the font within which such a sample string was generated, can also be stored in tabular form. According to one aspect such a table, illustrated as the exemplary table 179 in FIG. 1, can be retained as a separate file from the sample string font file 170. For example, the exemplary table 179 can be a separate JSON table, or other like data structure, and can comprise an identification of the font within which a sample string glyph was generated, the corresponding language, and the location of that sample string glyph. As indicated previously, the location of a sample string glyph can be specified as a code point, or other like location identifier within a font file. In such an aspect, where the exemplary table 179 is maintained as a separate file, or other like separate data structure, the location identification within such a table 179 can then be utilized to locate the corresponding glyph by reference to the table maintained within the font file, such as the exemplary table shown in the sample string font file 170 in FIG. 1.

According to another aspect, however, the exemplary table 179 can be part of the sample string font file 170, as represented by the dashed arrow. In such another aspect, the exemplary table 179 can still be maintained as a separate table within the sample string font file 170. Alternatively, the three-way correspondence illustrated in the exemplary table 179 can, instead, be maintained together with the location information, such that, rather than identifying a location of the sample string glyph, the correspondence can identify the sample string glyph directly. Such a correspondence can be maintained through a modified “cmap” table, or, in order to maintain backward compatibility, a new table within the sample string font file 170.

The sample string font file generator 160 can generate multiple sample string font files, such as exemplary sample string font file 170. For example, the sample string font file generator 160 can generate a sample string font file for each language. Thus, for example, the exemplary sample string font file 170, shown in FIG. 1, can be an English sample string font file, with each of the glyphs within the sample string font file 170 being a phrase, rendered in a specific font, and saved as a single glyph, where such a phrase is an English phrase. According to one aspect, the same phrase can be utilized for each font within a language specific sample string font file. According to another aspect, the sample string font file 170 can comprise a sample strings in each of multiple different languages that are all supported by the fonts within which such sample strings were rendered. Thus, for example, the exemplary sample string font file 170 can correspond to a particular subset of fonts 140, such as the fonts represented by the exemplary font files 141 and 142. In such an aspect, the sample string font file 170 can comprise sample strings in each language supported by the font represented by the exemplary font file 141. Similarly, the sample string font file 170 can comprise sample strings in each language supported by the font represented by the exemplary font file 142.

According to still further aspects, combinations of the above can be utilized in accordance with memory utilization or consumption thresholds and the like. For example, sample string font files can be generated such that no sample string font file exceeds a predetermined memory utilization or consumption threshold, such as, for example, 5 MB, 10 MB, 20 MB or any other like predetermined threshold.

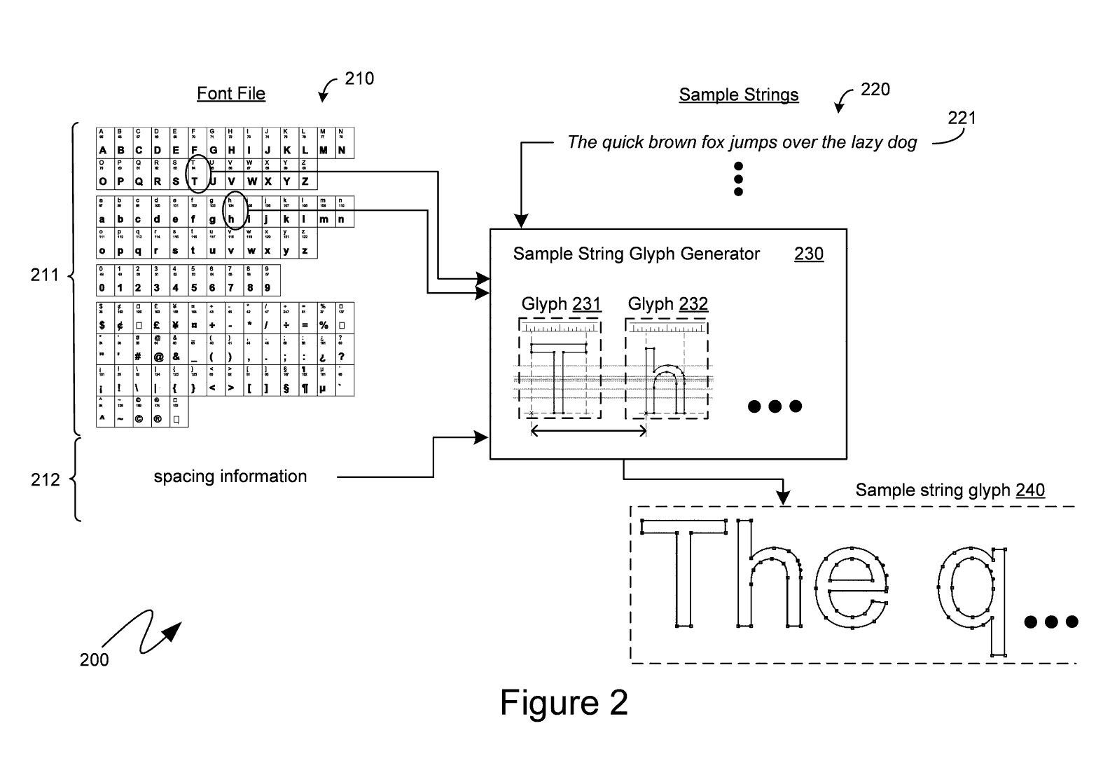

Turning to FIG. 2, the exemplary block diagram 200 shown therein illustrates an exemplary generation of a single sample string glyph, such as the exemplary sample string glyph 240. More specifically, as shown in FIG. 2, a font file, such as the exemplary font file 210, can comprise glyphs of individual characters of such a font, such as the exemplary glyphs 211. In addition, such a font file can comprise rendering information, such as spacing information, alignment, sizing, and other like rendering information. For ease of illustration, a portion of such rendering information, represented by the spacing information 212, is illustrated in FIG. 2. As indicated previously, a font file, such as the exemplary font file 210, can comprise information indicating the scripts or languages for which such a font file is usable. If such information is not part of the font file, it can be provided, such as part of the setup process for generating the sample string font files described previously. As also indicated previously, based on a specified language for which a font file, such as the exemplary font file 210, can be utilized, one or more sample strings 220, such as the exemplary sample string 221, can be selected.

Once a sample string, such as the exemplary sample string 221, is selected based on a language supported by the font file 210, the exemplary sample string glyph generator 230 can, character-by-character, obtain the glyphs of those characters from the glyphs 211, of the exemplary font file 210, and can assemble the exemplary sample string 221, as rendered in the font provided by the font file 210. For example, FIG. 2 illustrates exemplary sample string gyph generator 230 rendering the sample string “The quick brown fox jumps over the lazy dog” by obtaining the corresponding glyphs, such as the exemplary glyph 231, providing the rendering of the letter “T” in the font of the font file 210, and the exemplary glyph 232, providing the rendering of the letter “h” in the font of the font file 210. Moreover, rendering information, such as the exemplary spacing information 212, provided by the exemplary font file 210, enables the sample string glyph generator 230 to arrange, such as to visually arrange in a horizontal and vertical manner, the relevant glyphs, such as the exemplary glyphs 231 and 232, to render the exemplary sample string 221 in the font of the exemplary font file 210.

Once rendered, such as in the manner described and illustrated, the sample string, as rendered in the font, can be saved as a single glyph, such as the exemplary sample string glyph 240. Thus, as illustrated in FIG. 2, the single cohesive, undivided glyph 240 comprises all of the rendering information to enable a computing device to visually display, such as on one or more display devices communicationally couple to such a computing device, textual content corresponding to the sentence “The quick brown fox jumps over the lazy dog”, represented by the exemplary sample string 221, as rendered in the font represented by the exemplary font file 210. Such a single glyph 240 can then be saved in a sample string font file at one location.

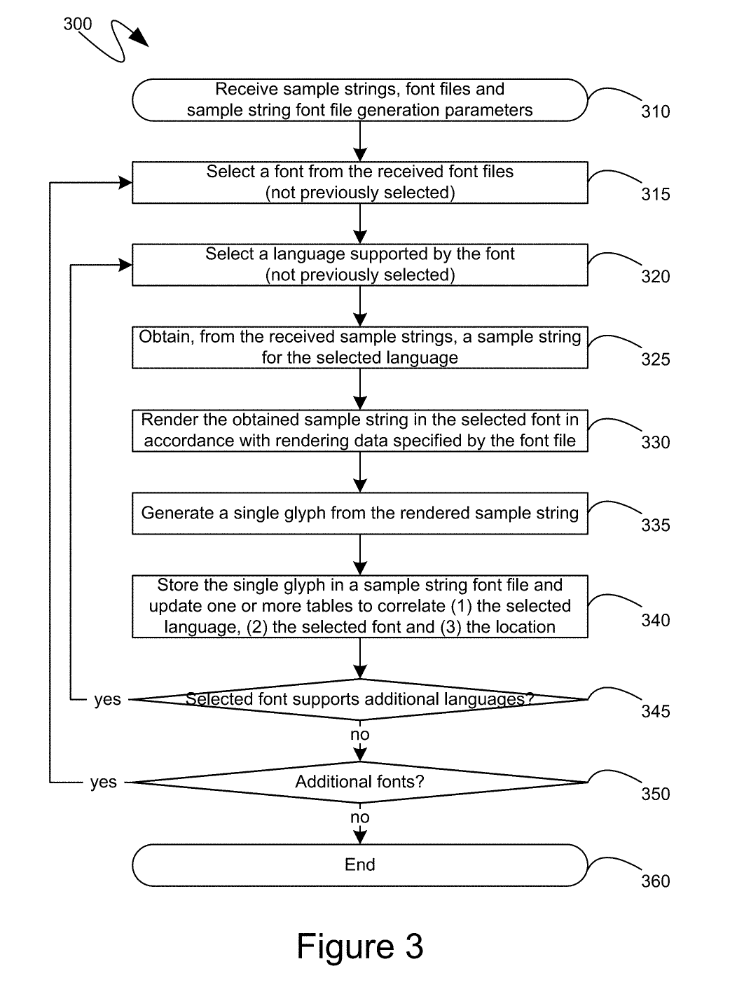

Turning to FIG. 3, the exemplary flow diagram 300 shown therein illustrates an exemplary series of steps by which one or more sample string font files can be generated. Initially, at step 310, sample strings corresponding to one or more languages can be received, as well as font files comprising the fonts for which sample strings are to be provided. According to one aspect, sample string font file generation parameters can also be received at step 310. Such sample string font file generation parameters can include information indicative of whether separate sample string font files are to be generated on a per-language basis, whether sample string font files are to remain below a predetermined memory storage or consumption threshold, whether sample string font files are to be generated on a per-font basis, and other like sample string font file generation parameters. Additionally, as one option, sample string font file generation parameters can include special instructions requiring a deviation from general operation. For example, certain fonts may comprise characters that are language agnostic, or for which a sample string need not be generated. As another example, certain fonts may have known issues or other like nuances that can be individually called out, such as within the aforementioned sample string font file generation parameters.

Subsequently, at step 315, processing can proceed to select a font, from among the font files received at step 310, which was not selected previously. At step 320, a determination can be made of which scripts or languages are supported by the font selected at step 315, such that the font selected at step 315 can be utilized to render textual content in such languages. One such language, not previously selected, can be selected at step 320. At step 325, a sample string, within such a language, can be obtained from the sample strings that were received at step 310.

Processing can then proceed to render the sample string obtained at step 325 within the font selected at step 315. As described previously, such a rendering can comprise utilization of rendering information contained within the font file itself, such as glyphs of the individual characters of the font, spacing information and the like. At step 335, a single cohesive, undivided glyph can be generated from the entire rendered sample string that was rendered at step 330. The single glyph generated at step 335 can then, at step 340, be stored as part of a sample string font file. Additionally, as part of step 341, one or more tables can be updated to correlate the language of the sample string, the font within which such a sample string was generated, and the location within the sample string font file at which the glyph generated at step 335 was stored, with such correlations being specified either directly, or indirectly such as through other tables,

As illustrated by the decision at step 345, steps 320 through 340 can be repeated for other languages supported by the font that was selected at step 315. As indicated previously, the sample string glyphs generated by step 335 can be stored in separate sample string font files, such as in accordance with the generation parameters received at step 310. Further, as illustrated by the decision at step 350, steps 315 through 345 can be repeated for other fonts from the font files that were received at step 310. Again, as indicated previously, the sample string glyphs generated by step 335 can be stored in separate sample string font files, such as in accordance with the generation parameters received at step 310. The relevant processing can then end at step 360.

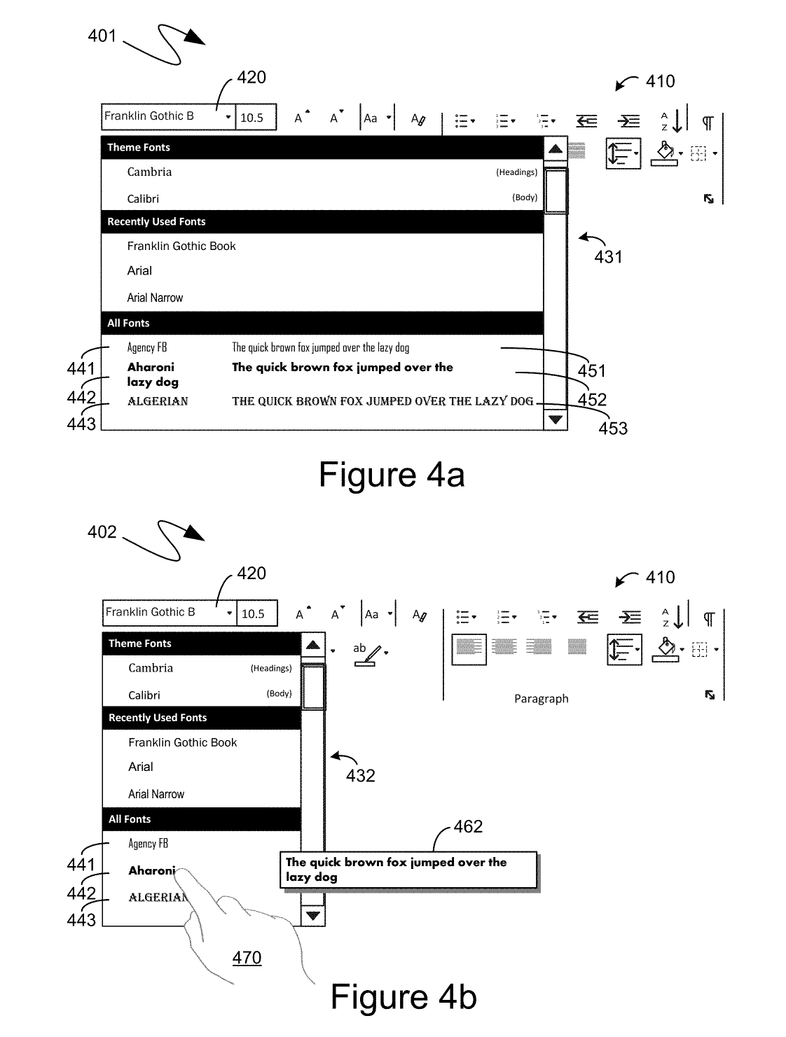

The sample string font files generated by the mechanisms detailed herein can consume substantially less storage capacity than the full font files of each of the fonts represented within such sample strings. Turning to FIGS. 4a and 4b, exemplary user interfaces for presenting such sample strings rendered in a given font are shown. For example, the exemplary user interface 401 of FIG. 4a illustrates a font menu, such as the exemplary font menu 431, through which the user can select a font to be applied to textual content, such as within the context of a content creation application, such as the ubiquitous word processing application. The exemplary font menu 431 can be triggered by user input directed to, for example, a font selection user interface 420, which can be part of a toolbar, such as the exemplary toolbar 410, of such a content creation application.

According to the aspect illustrated by the exemplary user interface 401, individual fonts shown in the exemplary font menu 431, such as the exemplary fonts 441, 442 and 443, can have shown with them, such as within the exemplary font menu 431 itself, sample strings rendered within those fonts, such as the exemplary sample strings 451, 452 and 453, rendered in the fonts 441, 442 and 443, respectively.

According to another aspect, such as that illustrated by the exemplary user interface 402 of FIG. 4b, the exemplary font menu 432 can comprise only the names of the fonts, such as the exemplary fonts 441, 442 and 443. Sample strings rendered in a given font can be displayed only upon user input, or other like indicia of user intent, directed to one or more such fonts. For example, user input 470, such as in the form of a touch, hover, click, or other like user input, directed to the exemplary font 442, can trigger presentation of a sample string, such as the exemplary sample string 462, rendered in the font 442.

As indicated previously, the presentation of sample strings, such as the exemplary sample strings 451, 452, 453 or 462 shown in FIGS. 4a and 4b need not be within the context of font menus or other like “drop-down” user interface structures. Instead, font selection dialog boxes, font information windows or screens, and other like user interface structures can, likewise, present sample strings analogous to those illustrated in FIGS. 4a and 4b. For example, a font selection screen can comprise font selection user interfaces, including drop-down menus, effects selection user interface elements, spacing and alignment text boxes and other like user input interface elements. Such a font selection screen can further comprise a preview area within which sample text can be rendered in a chosen font. Such sample text can, in whole or in part, comprise sample strings generated in accordance with the mechanisms described herein.

According to one aspect, the language of the sample strings need not match that of the font names themselves. For example, fonts names can be selected based upon a user interface language, such as that specified by operating system of a computing device. The user interface language can be the language within which user interface elements and notifications are presented to a user. Sample strings, according to such aspect, however, can be presented in an alternative language. For example, if a keyboard setting, or other like textual input setting, is set to a different language, then such a keyboard setting can be utilized to determine the language within which sample strings are presented.

According to one aspect, if sample string font files are saved on a per language basis, then only sample string font files corresponding to those languages for which the user has an installed keyboard setting can be downloaded, thereby saving additional storage capacity. According to another aspect, again, if sample string font files are saved on a per language basis, then the only sample string font file downloaded can be the one corresponding to a currently active language, such as a currently active keyboard setting. Optionally, or in addition, sample string font files can be deleted to save storage capacity. Such deletion can be triggered based upon a maximum storage capacity, being consumed by such sample string font files as stored on a local computing device, being exceeded, a threshold amount of time since a user last had a language setting for which such a sample string font file was relevant, the remaining amount of storage capacity available on a local computing device, and other like triggers.

In instances where the language within which a sample string is presented differs from the language within which a font is displayed, sizing can be taken into account to ensure corresponding visual size between the visual rendering of the font name and the visual rendering of the sample string. For example, the sample string can be sized based on the maximum visual height of the individual characters of the font name, as visually rendered on a display device, such that the sample string is sized to itself not exceed such a maximum visual height when it is visually rendered on the display device. As another example, the visual height of the font name, as visually rendered on a display device, can limit the minimum and maximum visual height of the sample string, when it is visually rendered on the display device, such as based on predetermined minimum and maximum thresholds that are expressed as a percentage of the maximum visual height of the font name as it is visually rendered on the display device.

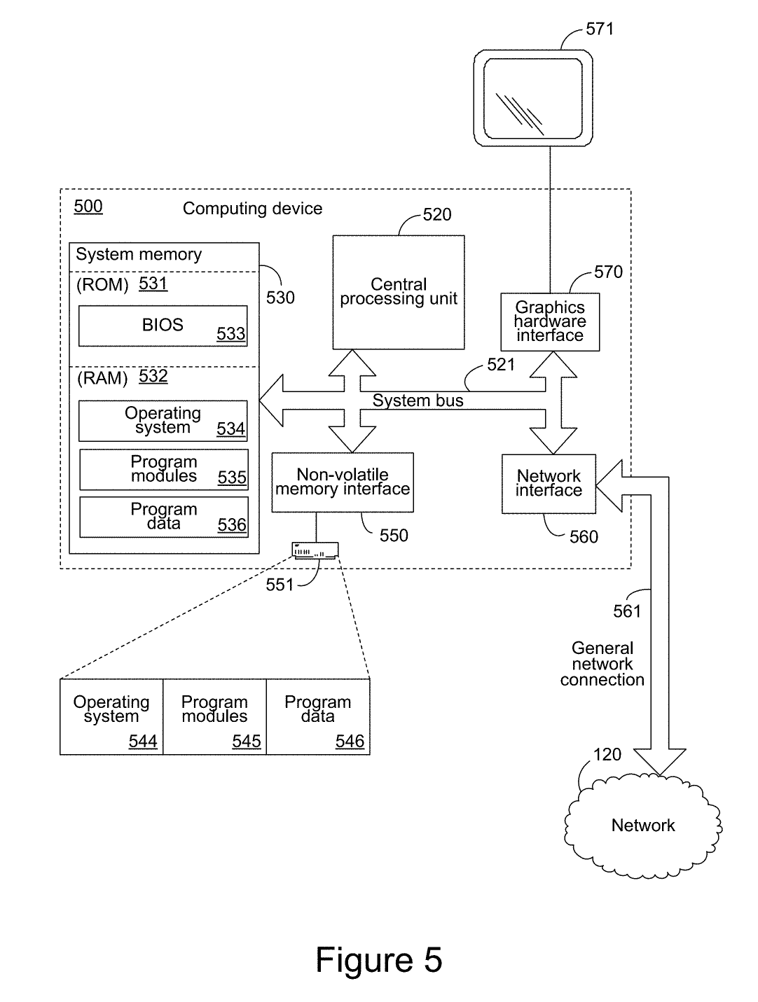

Turning to FIG. 5, an exemplary computing device 500 is illustrated which can perform some or all of the mechanisms and actions described above. The exemplary computing device 500 can include, but is not limited to, one or more central processing units (CPUs) 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, including, but not limited to, a graphics hardware interface 570 and a display device 571, which can include display devices capable of receiving touch-based user input, such as a touch-sensitive, or multi-touch capable, display device. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of content such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired content and which can be accessed by the computing device 500. Computer storage media, however, does not include communication media. Communication media typically embodies computer readable instructions, data structures, program modules or other data in a modulated data signal such as a carrier wave or other transport mechanism and includes any content delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer content between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, other program modules 535, and program data 536.

The computing device 500 may also include other removable/non-removable, volatile/nonvolatile computer storage media. By way of example only, FIG. 5 illustrates a hard disk drive 541 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 541 is typically connected to the system bus 521 through a non-volatile memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 546. Operating system 544, other program modules 545 and program data 546 are given different numbers hereto illustrate that, at a minimum, they are different copies.

The computing device 500 may operate in a networked environment using logical connections to one or more remote computers. The computing device 500 is illustrated as being connected to the general network connection 561 through a network interface or adapter 560, which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

Although described as a single physical device, the exemplary computing device 500 can be a virtual computing device, in which case the functionality of the above-described physical components, such as the CPU 520, the system memory 530, the network interface 560, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 500 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example is a set of one or more computing devices, in aggregate comprising: one or more processing units; and one or more computer-readable media comprising computer-executable instructions which, when executed by the one or more processing units, cause the set of computing devices to: identify a first language supported by a first selected font encoded in a first selected font file; render a sample textual content for the first language in the first selected font in accordance with rendering data from the first selected font file; encode the rendered sample textual content for the first language in the first selected font as a first single, cohesive glyph; store the first single, cohesive glyph at a first location within a sample string font file; and record, within one or more tables, a first correspondence between: (1) the first language, (2) the first selected font and (3) the first location.

A second example is the set of computing devices of the first example, wherein the one or more computer-readable media comprise further computer-executable instructions which, when executed by the one or more processing units, cause the set of computing devices to: identify a second language also supported by the first selected font; render a sample textual content for the second language in the first selected font in accordance with the rendering data from the first selected font file; encode the rendered sample textual content for the second language in the first selected font as a second single, cohesive glyph; store the second single, cohesive glyph at a second location within the sample string font file; and record, within the one or more tables, a second correspondence between: (1) the second language, (2) the first selected font and (3) the second location; wherein glyphs of sample textual content for languages that are supported by the first selected font are all stored in the sample string font file.

A third example is the set of computing devices of the first example, wherein the one or more computer-readable media comprise further computer-executable instructions which, when executed by the one or more processing units, cause the set of computing devices to: identify a second language also supported by the first selected font; render a sample textual content for the second language in the first selected font in accordance with the rendering data from the first selected font file; encode the rendered sample textual content for the second language in the first selected font as a second single, cohesive glyph; store the second single, cohesive glyph at a second location within a second, different sample string font file; and record, within the one or more tables, a second correspondence between: (1) the second language, (2) the selected font and (3) the second location; wherein glyphs of sample textual content for a first set of one or more languages are all stored in the sample string font file while glyphs of sample textual content for a second set of one or more languages are all stored in the second, different sample string font file, the first language being in the first set of one or more languages and the second language being in the second set of one or more languages, the first and second sets of one or more languages being mutually exclusive of one another.

A fourth example is the set of computing devices of the first example, wherein the one or more computer-readable media comprise further computer-executable instructions which, when executed by the one or more processing units, cause the set of computing devices to: select a second selected font, encoded in a second selected font file, that also supports the first language; render the sample textual content for the first language in the second selected font in accordance with the rendering data from the second selected font file; encode the rendered sample textual content for the first language in the second selected font as a second single, cohesive glyph; store the second single, cohesive glyph at a second location within the sample string font file; and record, within the one or more tables, a second correspondence between: (1) the first language, (2) the second selected font and (3) the second location; wherein glyphs of sample textual content for the first language in a first set of fonts are all stored in the sample string font file, the first selected font and the second selected font both being in the first set of fonts.

A fifth example is the set of computing devices of the first example, wherein glyphs of sample textual content for a set of languages supported by a first script are all stored in the sample string font file while glyphs of sample textual content for a set of languages supported by a second, different script are all stored in a second, different sample string font file, the set of languages supported by the first script being mutually exclusive of the set of languages supported by the second script.

A sixth example is the set of computing devices of the first example, wherein the rendering data from the first selected font file comprises spacing information between characters in specific character combinations as delineated in one or more tables of the first selected font file.

A seventh example is the set of computing devices of the first example, wherein the one or more tables comprise a first table that is external to the sample string font file and correlates (1) the first language, (2) the first selected font and (3) a first code point and a second, different table that is part of the sample string font file and correlates the first code point to the first location within the sample string font file.

An eighth example is the set of computing devices of the seventh example, wherein the first table is a JSON table and the second table is a cmap table.

A ninth example is a method for generating font files comprising sample textual content for one or more languages rendered in one or more fonts, the method comprising: identifying a first language supported by a first selected font encoded in a first selected font file; rendering a sample textual content for the first language in the first selected font in accordance with rendering data from the first selected font file; encoding the rendered sample textual content for the first language in the first selected font as a first single, cohesive glyph; storing the first single, cohesive glyph at a first location within a sample string font file; and recording, within one or more tables, a first correspondence between: (1) the first language, (2) the first selected font and (3) the first location.

A tenth example is the method of the ninth example, further comprising: identifying a second language also supported by the first selected font; rendering a sample textual content for the second language in the first selected font in accordance with the rendering data from the first selected font file; encoding the rendered sample textual content for the second language in the first selected font as a second single, cohesive glyph; storing the second single, cohesive glyph at a second location within the sample string font file; and recording, within the one or more tables, a second correspondence between: (1) the second language, (2) the first selected font and (3) the second location; wherein glyphs of sample textual content for languages that are supported by the first selected font are all stored in the sample string font file.

An eleventh example is the method of the ninth example, further comprising: identifying a second language also supported by the first selected font; rendering a sample textual content for the second language in the first selected font in accordance with the rendering data from the first selected font file; encoding the rendered sample textual content for the second language in the first selected font as a second single, cohesive glyph; storing the second single, cohesive glyph at a second location within a second, different sample string font file; and recording, within the one or more tables, a second correspondence between: (1) the second language, (2) the selected font and (3) the second location; wherein glyphs of sample textual content for a first set of one or more languages are all stored in the sample string font file while glyphs of sample textual content for a second set of one or more languages are all stored in the second, different sample string font file, the first language being in the first set of one or more languages and the second language being in the second set of one or more languages, the first and second sets of one or more languages being mutually exclusive of one another.

A twelfth example is the method of the ninth example, further comprising: selecting a second selected font, encoded in a second selected font file, that also supports the first language; rendering the sample textual content for the first language in the second selected font in accordance with the rendering data from the second selected font file; encoding the rendered sample textual content for the first language in the second selected font as a second single, cohesive glyph; storing the second single, cohesive glyph at a second location within the sample string font file; and recording, within the one or more tables, a second correspondence between: (1) the first language, (2) the second selected font and (3) the second location; wherein glyphs of sample textual content for the first language in a first set of fonts are all stored in the sample string font file, the first selected font and the second selected font both being in the first set of fonts.

A thirteenth example is the method of the ninth example, wherein glyphs of sample textual content for a set of languages supported by a first script are all stored in the sample string font file while glyphs of sample textual content for a set of languages supported by a second, different script are all stored in a second, different sample string font file, the set of languages supported by the first script being mutually exclusive of the set of languages supported by the second script.

A fourteenth example is the method of the ninth example, wherein the rendering data from the first selected font file comprises spacing information between characters in specific character combinations as delineated in one or more tables of the first selected font file.

A fifteenth example is the method of the ninth example, wherein the one or more tables comprise a first table that is external to the sample string font file and correlates (1) the first language, (2) the first selected font and (3) a first code point and a second, different table that is part of the sample string font file and correlates the first code point to the first location within the sample string font file.

A sixteenth example is a computing device comprising: one or more processing units; a display device; and one or more computer-readable media comprising computer-executable instructions which, when executed by the one or more processing units, cause the computing device to: identify a user interface language of the computing device based on a user interface setting; download a first sample string font file based on the first sample string font file comprising sample textual content for the identified user interface language of the computing device; and provide, to an operating system of the computing device, in response to a font selection user input, one or more single, cohesive glyphs from the first sample string font file, thereby causing the operating system to visually render, on the display device, in a device-optimized manner supported by the operating system, the one or more single, cohesive glyphs; wherein each single, cohesive glyph, of the one or more single, cohesive glyphs, comprises an entire sample textual content for the identified user interface language of the computing device in a single font.

A seventeenth example is the computing device of the sixteenth example, wherein the user interface setting is a currently active keyboard language setting.

An eighteenth example is the computing device of the sixteenth example, wherein the one or more computer-readable media comprise further computer-executable instructions which, when executed by the one or more processing units, cause the computing device to: identify a new user interface language of the computing device due to a change in the user interface setting; determine if the first sample string font file comprises sample textual content for the new user interface language of the computing device; and download a second sample string font file based on the second sample string font file comprising sample textual content for the new user interface language of the computing device if the determining reveals that the first sample string font file does not comprise sample textual content for the new user interface language of the computing device.

A nineteenth example is the computing device of the sixteenth example, wherein the one or more computer-readable media comprise further computer-executable instructions which, when executed by the one or more processing units, cause the computing device to: identify a visual height of a first font name textual content as visually rendered on the display device; select a size of a first single, cohesive glyph such that a visual height of a first sample textual content for the identified user interface language of the computing device in a first font matches the identified visual height of the first font name textual content, the first font having the first font name; wherein the first single, cohesive glyph comprises the first sample textual content for the identified user interface language of the computing device in the first font.

A twentieth example is the computing device of the sixteenth example, wherein the font selection user input is a user input triggering display, on the display device, of a drop-down font selection menu.

As can be seen from the above descriptions, mechanisms for generating and utilizing sample string font files, comprising individual glyphs of sample strings rendered in specific fonts have been presented. In view of the many possible variations of the subject matter described herein, we claim as our invention all such embodiments as may come within the scope of the following claims and equivalents thereto.

We claim:

1. A set of one or more computing devices, in aggregate comprising:
one or more processing units; and
one or more computer-readable media comprising computer-executable instructions which, when executed by the one or more processing units, cause the set of computing devices to:
identify a first language supported by a first selected font encoded in a first selected font file;
render a sample textual content for the first language in the first selected font in accordance with rendering data from the first selected font file;
encode the rendered sample textual content for the first language in the first selected font as a first single, cohesive glyph;
store the first single, cohesive glyph at a first location within a sample string font file; and
record, within one or more tables, a first correspondence between: (1) the first language, (2) the first selected font and (3) the first location.

2. The set of computing devices of claim 1, wherein the one or more computer-readable media comprise further computer-executable instructions which, when executed by the one or more processing units, cause the set of computing devices to:
identify a second language also supported by the first selected font;
render a sample textual content for the second language in the first selected font in accordance with the rendering data from the first selected font file;
encode the rendered sample textual content for the second language in the first selected font as a second single, cohesive glyph;
store the second single, cohesive glyph at a second location within the sample string font file; and
record, within the one or more tables, a second correspondence between: (1) the second language, (2) the first selected font and (3) the second location;
wherein glyphs of sample textual content for languages that are supported by the first selected font are all stored in the sample string font file.

3. The set of computing devices of claim 1, wherein the one or more computer-readable media comprise further computer-executable instructions which, when executed by the one or more processing units, cause the set of computing devices to:
identify a second language also supported by the first selected font;
render a sample textual content for the second language in the first selected font in accordance with the rendering data from the first selected font file;
encode the rendered sample textual content for the second language in the first selected font as a second single, cohesive glyph;
store the second single, cohesive glyph at a second location within a second, different sample string font file; and
record, within the one or more tables, a second correspondence between: (1) the second language, (2) the selected font and (3) the second location;
wherein glyphs of sample textual content for a first set of one or more languages are all stored in the sample string font file while glyphs of sample textual content for a second set of one or more languages are all stored in the second, different sample string font file, the first language being in the first set of one or more languages and the second language being in the second set of one or more languages, the first and second sets of one or more languages being mutually exclusive of one another.

4. The set of computing devices of claim 1, wherein the one or more computer-readable media comprise further computer-executable instructions which, when executed by the one or more processing units, cause the set of computing devices to:
select a second selected font, encoded in a second selected font file, that also supports the first language;
render the sample textual content for the first language in the second selected font in accordance with the rendering data from the second selected font file;
encode the rendered sample textual content for the first language in the second selected font as a second single, cohesive glyph;
store the second single, cohesive glyph at a second location within the sample string font file; and
record, within the one or more tables, a second correspondence between: (1) the first language, (2) the second selected font and (3) the second location;
wherein glyphs of sample textual content for the first language in a first set of fonts are all stored in the sample string font file, the first selected font and the second selected font both being in the first set of fonts.

5. The set of computing devices of claim 1, wherein glyphs of sample textual content for a set of languages supported by a first script are all stored in the sample string font file while glyphs of sample textual content for a set of languages supported by a second, different script are all stored in a second, different sample string font file, the set of languages supported by the first script being mutually exclusive of the set of languages supported by the second script.

6. The set of computing devices of claim 1, wherein the rendering data from the first selected font file comprises spacing information between characters in specific character combinations as delineated in one or more tables of the first selected font file.

7. The set of computing devices of claim 1, wherein the one or more tables comprise a first table that is external to the sample string font file and correlates (1) the first language, (2) the first selected font and (3) a first code point and a second, different table that is part of the sample string font file and correlates the first code point to the first location within the sample string font file.

8. The set of computing devices of claim 7, wherein the first table is a JSON table and the second table is a cmap table.

9. A method for generating font files comprising sample textual content for one or more languages rendered in one or more fonts, the method comprising:
identifying a first language supported by a first selected font encoded in a first selected font file;
rendering a sample textual content for the first language in the first selected font in accordance with rendering data from the first selected font file;
encoding the rendered sample textual content for the first language in the first selected font as a first single, cohesive glyph;
storing the first single, cohesive glyph at a first location within a sample string font file; and
recording, within one or more tables, a first correspondence between: (1) the first language, (2) the first selected font and (3) the first location.

10. The method of claim 9, further comprising:
identifying a second language also supported by the first selected font;
rendering a sample textual content for the second language in the first selected font in accordance with the rendering data from the first selected font file;
encoding the rendered sample textual content for the second language in the first selected font as a second single, cohesive glyph;
storing the second single, cohesive glyph at a second location within the sample string font file; and
recording, within the one or more tables, a second correspondence between: (1) the second language, (2) the first selected font and (3) the second location;
wherein glyphs of sample textual content for languages that are supported by the first selected font are all stored in the sample string font file.

11. The method of claim 9, further comprising:
identifying a second language also supported by the first selected font;
rendering a sample textual content for the second language in the first selected font in accordance with the rendering data from the first selected font file;
encoding the rendered sample textual content for the second language in the first selected font as a second single, cohesive glyph;
storing the second single, cohesive glyph at a second location within a second, different sample string font file; and
recording, within the one or more tables, a second correspondence between: (1) the second language, (2) the selected font and (3) the second location;
wherein glyphs of sample textual content for a first set of one or more languages are all stored in the sample string font file while glyphs of sample textual content for a second set of one or more languages are all stored in the second, different sample string font file, the first language being in the first set of one or more languages and the second language being in the second set of one or more languages, the first and second sets of one or more languages being mutually exclusive of one another.

12. The method of claim 9, further comprising:
selecting a second selected font, encoded in a second selected font file, that also supports the first language;
rendering the sample textual content for the first language in the second selected font in accordance with the rendering data from the second selected font file;
encoding the rendered sample textual content for the first language in the second selected font as a second single, cohesive glyph;
storing the second single, cohesive glyph at a second location within the sample string font file; and
recording, within the one or more tables, a second correspondence between: (1) the first language, (2) the second selected font and (3) the second location;
wherein glyphs of sample textual content for the first language in a first set of fonts are all stored in the sample string font file, the first selected font and the second selected font both being in the first set of fonts.

13. The method of claim 9, wherein glyphs of sample textual content for a set of languages supported by a first script are all stored in the sample string font file while glyphs of sample textual content for a set of languages supported by a second, different script are all stored in a second, different sample string font file, the set of languages supported by the first script being mutually exclusive of the set of languages supported by the second script.

14. The method of claim 9, wherein the rendering data from the first selected font file comprises spacing information between characters in specific character combinations as delineated in one or more tables of the first selected font file.

15. The method of claim 9, wherein the one or more tables comprise a first table that is external to the sample string font file and correlates (1) the first language, (2) the first selected font and (3) a first code point and a second, different table that is part of the sample string font file and correlates the first code point to the first location within the sample string font file.

16. A computing device comprising:
one or more processing units;
a display device; and
one or more computer-readable media comprising computer-executable instructions which, when executed by the one or more processing units, cause the computing device to:
identify a user interface language of the computing device based on a user interface setting;
download a first sample string font file based on the first sample string font file comprising sample textual content for the identified user interface language of the computing device; and
provide, to an operating system of the computing device, in response to a font selection user input, one or more single, cohesive glyphs from the first sample string font file, thereby causing the operating system to visually render, on the display device, in a device-optimized manner supported by the operating system, the one or more single, cohesive glyphs;
wherein each single, cohesive glyph, of the one or more single, cohesive glyphs, comprises an entire sample textual content for the identified user interface language of the computing device in a single font.

17. The computing device of claim 16, wherein the user interface setting is a currently active keyboard language setting.

18. The computing device of claim 16, wherein the one or more computer-readable media comprise further computer-executable instructions which, when executed by the one or more processing units, cause the computing device to:
identify a new user interface language of the computing device due to a change in the user interface setting;
determine if the first sample string font file comprises sample textual content for the new user interface language of the computing device; and
download a second sample string font file based on the second sample string font file comprising sample textual content for the new user interface language of the computing device if the determining reveals that the first sample string font file does not comprise sample textual content for the new user interface language of the computing device.

19. The computing device of claim 16, wherein the one or more computer-readable media comprise further computer-executable instructions which, when executed by the one or more processing units, cause the computing device to:
identify a visual height of a first font name textual content as visually rendered on the display device;
select a size of a first single, cohesive glyph such that a visual height of a first sample textual content for the identified user interface language of the computing device in a first font matches the identified visual height of the first font name textual content, the first font having the first font name;
wherein the first single, cohesive glyph comprises the first sample textual content for the identified user interface language of the computing device in the first font.

20. The computing device of claim 16, wherein the font selection user input is a user input triggering display, on the display device, of a drop-down font selection menu.
